(19) United States
(12) Patent Application Publication
(10) Pub. No.: US 2016/0108293 A1
(43) Pub. Date: Apr. 21, 2016

(54) INKS, COATINGS AND ADHESIVES AS CARRIERS FOR TAGGANTS FOR TOBACCO PRODUCT AUTHENTICATION AND COMPONENT DETECTION

(71) Applicant: ALTRIA CLIENT SERVICES INC., Richmond, VA (US)

(72) Inventors: Edmond J. Cadieux, JR., Mechanicsville, VA (US); Christopher N. Chance, Chesterfield, VA (US); Stuart Payne, North Chesterfield, VA (US); Robert Kikkert, Charles City, VA (US)

(21) Appl. No.: 14/883,200

(22) Filed: Oct. 14, 2015

Related U.S. Application Data
(60) Provisional application No. 62/064,918, filed on Oct. 16, 2014.

(51) Int. Cl. C09J 11/06; C09J 103/10; C09J 105/00; C09D 11/03; C08K 5/00; B42D 25/378; C09J 131/04; A24D 1/00; A24D 1/02; A24C 5/34; G01N 21/64; C09J 103/02; C08K 5/3417

(52) U.S. Cl. CPC C09J 11/06; C09J 103/02; C09J 103/10; C09J 105/00; C09D 11/03; C08K 5/0008; C08K 5/3417; C09J 131/04; A24D 1/002; A24D 1/02; A24C 5/3412; G01N 21/64; B42D 25/378; G01N 2201/0633

(57) ABSTRACT

Organic, fluorescent taggants and compositions thereof which find use in the production, detection and authentication of tobacco products and components thereof. A process for authentication of a tobacco product is also disclosed, the process including the steps of marking the tobacco product with a taggant composition comprising an organic, fluorescent taggant and a carrier for the taggant; irradiating the tobacco product with invisible radiation; and detecting fluorescence from the taggant. Adhesive and ink compositions are also disclosed.

### RELATED APPLICATION

This application claims priority to U.S. Provisional Application No. 62/064,918, filed Oct. 16, 2014, the contents of which are hereby incorporated by reference in their entirety.

### FIELD

Disclosed herein are taggant compositions and processes for component detection and authentication of tobacco products and packaging.

### BACKGROUND

Recently, the import, provision or sale of unauthorized tobacco products has become epidemic. The art of printing tobacco product packaging has become easily reproduced due to computer enhancements, and counterfeiters can readily reproduce even complex package designs with relative ease. Sale of such counterfeit packages and the tobacco products provided therein can result in greatly reduced earnings for the legitimate tobacco product producer whose articles are subject to counterfeiting. Likewise, a lack of quality control in the production of tobacco products by a counterfeiting producer can negatively reflect on the legitimate tobacco product producer.

Accordingly, it would be advantageous if tobacco products and/or packaging therefore could be readily authenticated, preferably by a simple visual inspection of the product or package. Upon identification of a counterfeit package or product, appropriate legal remedies, such as confiscation, could be sought and applied against the possessor of those counterfeit products.

### SUMMARY

In one aspect, disclosed is an adhesive composition. The adhesive composition includes an organic taggant compound and an adhesive which decomposes upon pyrolysis or combustion primarily to carbon dioxide and water.

In one form, the organic taggant is one which decomposes upon pyrolysis or combustion primarily to carbon dioxide and water.

In another form, the organic taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

In yet another form, the organic taggant is a Stokes shifting taggant.

In still yet another form, the organic taggant is selected from the group consisting of quinine, fluorescein, carmine, indocyanine green and derivatives thereof.

In a further form, the organic taggant is present in the composition at a concentration from about 3 ppmw to about 50 wt %.

In a yet further form, the adhesive is a water soluble vegetable starch, dextrin or derivative thereof.

In a still yet further form, the adhesive is an oxidatively- or hydrolytically-degraded starch or dextrin.

In another form, the vegetable starch is a starch selected from potato starch, corn starch, tapioca starch or rice starch.

In yet another form, the adhesive is an α-D-glucose biopolymer.

In another aspect, disclosed is a tobacco product comprising a tobacco rod, a wrapper and an adhesive disposed on the tobacco product, wherein the adhesive is one which decomposes upon pyrolysis or combustion primarily to carbon dioxide and water and further comprises an organic taggant compound.

In one form, the product is a cigarette and the adhesive is disposed on a tobacco rod wrapper.

In another form, the product is a cigar and the adhesive is disposed on a tobacco rod wrapper which comprises tobacco.

In yet another form, the adhesive is a water soluble vegetable starch, dextrin or derivative thereof and the organic taggant is a Stokes shifting taggant which decomposes upon pyrolysis or combustion primarily to carbon dioxide and water.

In still yet another form, the organic taggant is detectable by visual inspection upon irradiation with non-visible radiation.

In a further form, the organic taggant is present in the adhesive at a concentration from about 3 ppmw to about 50 wt %.

In a still further form, the adhesive is disposed on the filter tack line.

In a still yet further form, the adhesive is disposed on the wrapper seam.

In yet another aspect, disclosed is a process for authentication of a tobacco product, comprising marking the tobacco product with a taggant composition comprising an organic, fluorescent taggant and a carrier for the taggant, irradiating the tobacco product with invisible radiation, and detecting fluorescence from the taggant.

In one form, the organic, fluorescent taggant is one which decomposes upon pyrolysis or combustion primarily to carbon dioxide and water.

In another form, the organic, fluorescent taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

In yet another form, the organic, fluorescent taggant is a Stokes shifting taggant.

In still yet another form, the organic, fluorescent taggant is selected from the group consisting of quinine, fluorescein, carmine, indocyanine green and derivatives thereof.

In a further form, the carrier is selected from the group consisting of inks, adhesives and varnishes, and the organic, fluorescent taggant is present in the taggant composition at a concentration of between about 3 ppmw and about 50 wt %.

In a still further form, the taggant composition comprises the organic, fluorescent taggant in an adhesive carrier and is disposed on a tobacco rod.

In a still yet further form, the taggant composition comprises the organic, fluorescent taggant in a jettable ink carrier, further comprising disposing the taggant composition with an ink jet printer onto an exterior portion of a container for the tobacco product.

In another form, the taggant composition comprises the organic, fluorescent taggant in a carrier varnish, further comprising disposing the taggant composition onto a cardboard preprint prior to cutting and folding the cardboard preprint into containers for the tobacco product.

In a further aspect, a process for detecting a tobacco product component is provided. The process includes marking the tobacco product component with a taggant composition comprising an organic, fluorescent taggant and a carrier for the taggant; irradiating the tobacco product component with invisible radiation; and detecting fluorescence from the taggant.

In one form, the organic, fluorescent taggant is one which decomposes upon pyrolysis or combustion primarily to carbon dioxide and water.

In another form, the organic, fluorescent taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

In yet another form, the organic, fluorescent taggant is a Stokes shifting taggant.

In still yet another form, the organic, fluorescent taggant is selected from the group consisting of quinine, fluorescein, carmine, indocyanine green and derivatives thereof.

In a further for, the carrier is selected from the group consisting of inks, adhesives and varnishes, and the organic, fluorescent taggant is present in the taggant composition at a concentration of between about 0.5 ppmw and about 1.0 wt %.

In a still further form, the taggant composition comprises the organic, fluorescent taggant in an adhesive carrier and is disposed on a tobacco product component.

In a yet further aspect, an ink composition is provided that includes an organic taggant compound and an ink.

In one form, the organic taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

In another form, the organic taggant is a Stokes shifting taggant.

In yet another form, the organic taggant is selected from the group consisting of quinine, fluorescein, carmine, indocyanine green and derivatives thereof.

In still yet another form, the organic taggant is present in the composition at a concentration from about 0.5 ppmw to about 1.0 wt %.

### BRIEF DESCRIPTION OF THE DRAWINGS

The forms disclosed herein are illustrated by way of example, and not by way of limitation, in the figures of the accompanying drawings and in which like reference numerals refer to similar elements and in which:

FIG. 1 is a representation of the infrared absorption and emission peaks of the Indocyanine Green (ICG) complex taggant, illustrating the Stokes-shift;

FIG. 2 is a representation of the infrared absorption and emission peaks of a modified ICG-complex, illustrating a secondary emission peak;

FIG. 3 is a representation of the infrared absorption peak for the modified ICG-complex of Example 1; and

FIG. 4 is a representation of the infrared excitation and emission peaks for the modified ICG-complex of Example 1.

### DETAILED DESCRIPTION

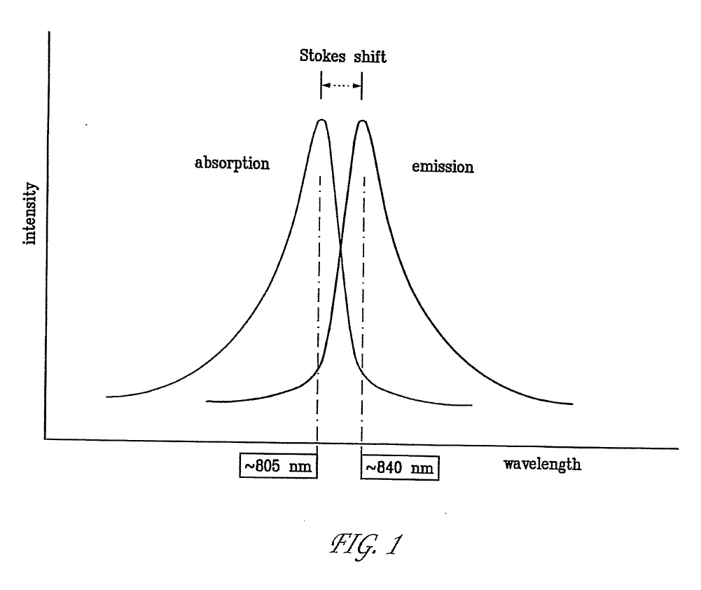

Various aspects will now be described with reference to specific forms selected for purposes of illustration. It will be appreciated that the spirit and scope of the apparatus, system and methods disclosed herein are not limited to the selected forms. Moreover, it is to be noted that the figures provided herein are not drawn to any particular proportion or scale, and that many variations can be made to the illustrated forms. Reference is now made to FIGS. 1-4, wherein like numerals are used to designate like elements throughout.

Each of the following terms written in singular grammatical form: “a,” “an,” and “the,” as used herein, may also refer to, and encompass, a plurality of the stated entity or object, unless otherwise specifically defined or stated herein, or, unless the context clearly dictates otherwise. For example, the phrases “a device,” “an assembly,” “a mechanism,” “a component,” and “an element,” as used herein, may also refer to, and encompass, a plurality of devices, a plurality of assemblies, a plurality of mechanisms, a plurality of components, and a plurality of elements, respectively.

Each of the following terms: “includes,” “including,” “has,” “having,” “comprises,” and “comprising,” and, their linguistic or grammatical variants, derivatives, and/or conjugates, as used herein, means “including, but not limited to.”

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein.

Moreover, for stating or describing a numerical range, the phrase “in a range of between about a first numerical value and about a second numerical value,” is considered equivalent to, and means the same as, the phrase “in a range of from about a first numerical value to about a second numerical value,” and, thus, the two equivalently meaning phrases may be used interchangeably.

It is to be understood that the various forms disclosed herein are not limited in their application to the details of the order or sequence, and number, of steps or procedures, and sub-steps or sub-procedures, of operation or implementation of forms of the method or to the details of type, composition, construction, arrangement, order and number of the system, system sub-units, devices, assemblies, sub-assemblies, mechanisms, structures, components, elements, and configurations, and, peripheral equipment, utilities, accessories, and materials of forms of the system, set forth in the following illustrative description, accompanying drawings, and examples, unless otherwise specifically stated herein. The apparatus, systems and methods disclosed herein can be practiced or implemented according to various other alternative forms and in various other alternative ways.

It is also to be understood that all technical and scientific words, terms, and/or phrases, used herein throughout the present disclosure have either the identical or similar meaning as commonly understood by one of ordinary skill in the art, unless otherwise specifically defined or stated herein. Phraseology, terminology, and, notation, employed herein throughout the present disclosure are for the purpose of description and should not be regarded as limiting.

Disclosed herein are adhesive compositions comprising an organic taggant compound and an adhesive which decomposes upon pyrolysis or combustion primarily to carbon dioxide and water. Advantageously, the adhesive composition additionally has an organic taggant which decomposes upon pyrolysis or combustion primarily to carbon dioxide and water.

As used herein the term “organic” means organic compounds which are composed almost entirely of carbon, hydrogen, nitrogen and oxygen. Thus, with the exception of being present in trace amounts (less than 50 PPB), taggant compounds which contain metals and/or sulfur, commonly used for imparting fluorescence, are not within the scope of the term “organic”, as used herein.

The phrase “decomposes upon pyrolysis or combustion primarily to carbon dioxide and water” means that the combustion or pyrolysis products of these materials comprises mostly, if not entirely carbon dioxide and water, and contains only very minor or trace amounts of other combustion products

The adhesive which primarily decomposes to carbon dioxide and water upon pyrolysis or combustion is one typically used for gluing portions of tobacco rods, such as at the seam of the tobacco rod wrapping paper or leaf wrapper, or at the filter tack line, which is the interface between the tobacco rod and a filter, or even for gluing tobacco product boxes or other such containers and/or wrappers surrounding the boxes or containers. For example, the adhesive can be a water soluble vegetable starch, dextrin or derivative thereof, such as an oxidatively- or hydrolytically-degraded starch or dextrin. In one form, the adhesive is a vegetable starch selected from potato starch, corn starch, tapioca starch or rice starch. Additionally, the adhesive can be an α-D-glucose biopolymer.

In one form, the adhesive can be a commercially available polyvinyl acetate (PVA), such as those produced by H. B. Fuller of St. Paul, Minn. PVA adhesives are known to have utility in high speed packaging operations.

In one form, the organic taggant is a Stokes shifting taggant, which fluoresces under light, preferably invisible light such as ultraviolet light, and emits color in the visible light spectrum. Generally, ultraviolet light used for detection has a wavelength from about 200 nm to about 390 nm, and the excitation wavelength of the organic taggant occurs in this portion of the electromagnetic spectrum. Upon excitation, atoms in the organic taggant emit a lower frequency, longer wavelength light (a Stokes shift) as compared to the excitation light, which is advantageously in the visible light spectrum, generally with wavelengths from about 391 nm to about 700 nm, which visible fluorescence enables easy identification of the organic taggant by an observer.

Alternatively, the organic taggants can be selected from anti-Stokes shifting taggants, commonly known as “up-shifting” taggants, which are excited by light having a lower frequency and longer wavelength, and emit light having a higher frequency and shorter wavelength as compared to the excitation light. For example, an excitation light beam having wavelengths in the infrared spectrum, generally from about 701 nm to about 3000 nm, is directed to the area of the tobacco product which contains the taggant, and the anti-Stokes shifting taggant emits light of a higher frequency and shorter wavelength than the excitation beam. When the emission wavelength of the taggant is in the infrared spectrum, it can be necessary to utilize a detection apparatus having a sensor which is sensitive to infrared light, such as one disclosed in U.S. Ser. No. 13/482,771, filed May 29, 2012, which is incorporated by reference herein in its entirety.

The disclosed organic taggants likewise decompose primarily to carbon dioxide and water upon pyrolysis or combustion and can be selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof. In one form, the organic taggant is selected from the group consisting of quinine, fluorescein, carmine and indocyanine green and derivatives thereof.

In one form, the taggant may be an organic compound comprised of purified crystals from naturally occurring chlorophyll. Suitable naturally-occurring chlorophyll crystals include Chlorophyll A (CAS number 1406-65-1) and Chlorophyll B (CAS number 519-62-0). These taggants are known as being down-converting or fluorescent, and are sensitive to a particular narrow wavelength of IR light (680 nanometers). The taggant emits back this particular of light at a different wavelength (715 nanometers).

A similar compound may be a benze-indolium perchlorate or a benze-indolium tosolyate. Such materials absorb around 670 nanometers and emit at a wavelength of 713 nanometers.

Another material with down-conversion properties is Indocyanine Green (ICG). The chemical structure for Chlorophyll A is provided below.

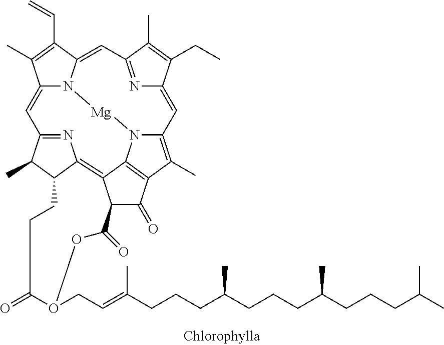

The chemical structure of Indocyanine Green (ICG) is provided below.

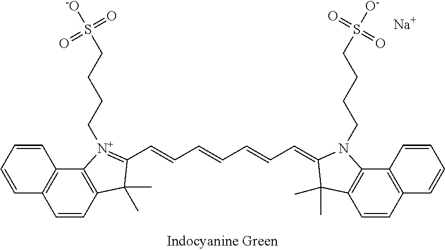

ICG is sodium 4-[2-[(1E,3E,5E,7Z)-7-[1,1-dimethyl-3-(4-sulfonatobutyl)-benzo[e]indol-2-ylidene]hepta-1,3,5-trienyl]-1,1-dimethyl-benzo[e]indol-3-ium-3-yl]butane-1-sulfonate, an infrared fluorescing compound currently used in the medical industry for imaging cells and blood flows in the human body, which in its conventional form is water-soluble.

Should an oil-soluble ICG-complex be required, one may be obtained from Persis Science LLC, Andreas PA. The chemical structure for a tetrabutylammonium chloride complexation of ICG is provided below.

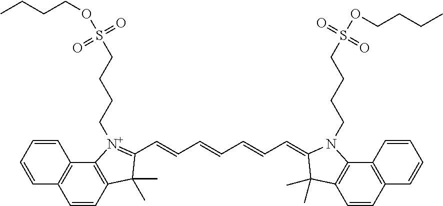 [SMILES: CCCCOS(=O)(=O)CCCCN1/C(=C/C=C/C=C/C=C/C2=[N+](CCCCS(=O)(=O)OCCCC)c3c(ccc4ccccc34)C2(C)C)C(C)(C)c2ccc3ccccc3c21]

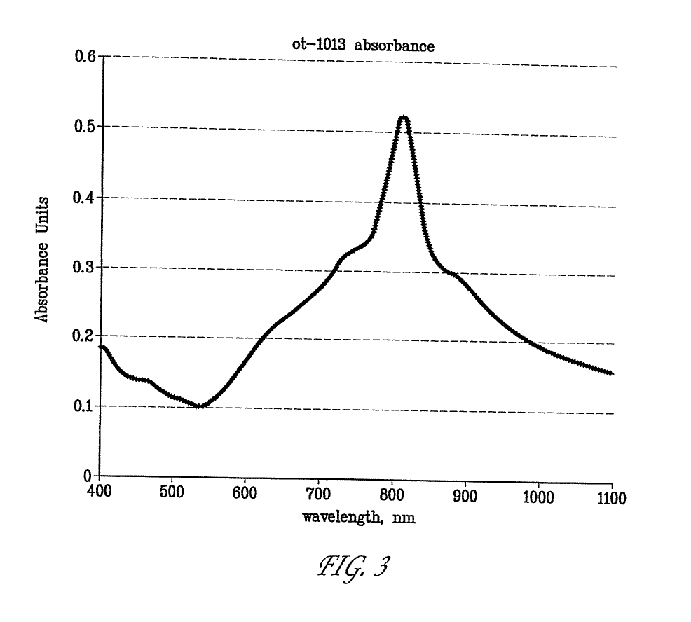

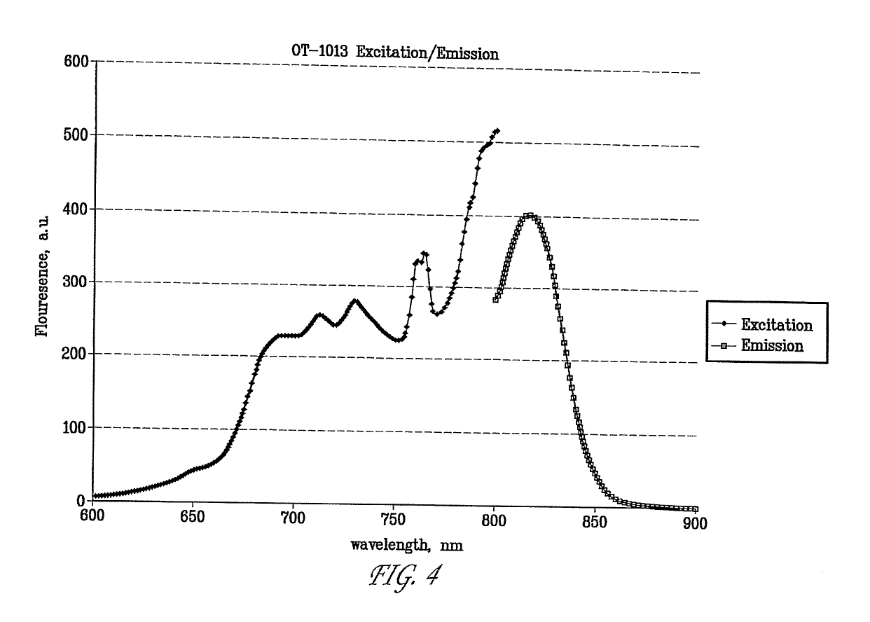

The above ICG-complex is sensitive to a particular narrow absorption band of IR light between about 760 to about 810 nanometers (FIG. 3), and emits light at a different band between about 810 to about 840 nanometers (FIG. 4), with discrete absorbance peaks at about 785 nanometers (FIGS. 4) and 805 nanometers (FIG. 1), and a discrete emission peak at about 840 nanometers (FIG. 1).

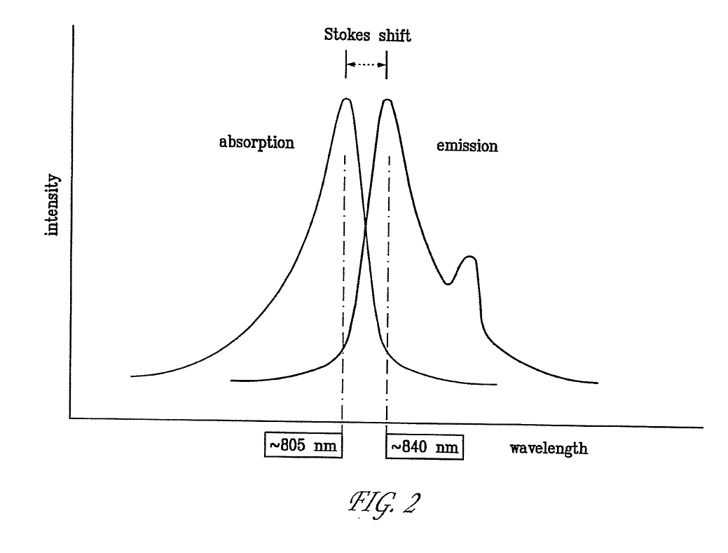

Additionally, the nature of the ICG complexing agent can be modified to impart one or more secondary NIR emission wavelengths adjacent to the major emission peak at 840 nanometers. FIG. 2 is an illustration of the absorption and emission peaks of a modified ICG-complex, showing a secondary emission peak of a longer wavelength on the shoulder of the primary emission peak.

In accordance herewith, the organic taggant is present in the composition at a concentration from about 0.5 ppmw to about 1.0 wt %, or from about 1 ppmw to about 100 ppmw, or from about 3 ppmw to about 50 ppmw.

In another form a tobacco product is provided comprising a tobacco rod, a wrapper and an adhesive disposed on the tobacco product, wherein the adhesive is one which decomposes upon pyrolysis or combustion primarily to carbon dioxide and water and further comprises an organic taggant compound. For example, the tobacco product can be a cigarette and the adhesive disposed on a seam of the tobacco rod wrapping paper thereof, or the product can be a cigar and the adhesive disposed on the seam of the tobacco leaf wrapper. Additionally, the adhesive can be disposed on a filter tack line of the tobacco rod. The suitable adhesives and organic taggants useful in this form are disclosed in detail above, and need not be repeated here.

Advantageously, the organic taggant is detectable by visual inspection upon irradiation with non-visible radiation, and is present in the adhesive at a concentration from about 0.5 ppmw to about 1.0 wt %, or from about 1 ppmw to about 100 ppmw, or from about 3 ppmw to about 50 ppmw.

Additionally, a process for authentication of a tobacco product is provided, comprising marking the tobacco product with a taggant composition comprising an organic, fluorescent taggant and a carrier for the taggant, irradiating the tobacco product with invisible radiation, and detecting fluorescence from the taggant. The suitable organic taggants useful in this form are disclosed in detail above, and need not be repeated here.

According to this aspect, the carrier can be selected from the group consisting of inks, adhesives and varnishes, and the organic, fluorescent taggant is present in the taggant composition at a concentration from about 0.5 ppmw to about 1.0 wt %, or from about 1 ppmw to about 100 ppmw, or from about 3 ppmw to about 50 ppmw.

Advantageously, the taggant composition comprises an organic, fluorescent taggant as described in detail above, in an adhesive carrier and is disposed on a tobacco rod.

In another form, the taggant composition comprises the organic, fluorescent taggant in a jettable ink carrier, as are well known in the art and the method further comprises disposing the taggant composition with an ink jet printer onto an exterior portion of a container for the tobacco product. In this manner, authentication of the tobacco product can be easily conducted by irradiating the product container with light of the appropriate wavelength(s) and observing fluorescence from the fluorescent taggant, either visually or by use of a suitable detector having a sensor sensitive to light emitted from the taggant.

In another form, the taggant composition comprises the organic, fluorescent taggant in a carrier varnish, and the method further comprises disposing the taggant composition onto a cardboard preprint prior to cutting and folding the cardboard preprint into containers for the tobacco product. According to this form, the taggant composition can be deposited on a very small and inconspicuous portion of the tobacco product container.

In both of these latter forms, since the taggant composition can be formulated to be essentially invisible to the naked eye, only the product manufacturer will know where the authentication mark is deposited, and the mark will not be easily reproduced by prospective counterfeiters.

In another form, a process for detecting a tobacco product component is provided. The process includes marking the tobacco product component with a taggant composition comprising an organic, fluorescent taggant and a carrier for the taggant; irradiating the tobacco product component with invisible radiation; and detecting fluorescence from the taggant.

According to this aspect of the invention, the carrier can be selected from the group consisting of inks, adhesives and varnishes, and the organic, fluorescent taggant is present in the taggant composition at a concentration from about 0.5 ppmw to about 1.0 wt %, or from about 1 ppmw to about 100 ppmw, or from about 3 ppmw to about 50 ppmw.

Advantageously, the taggant composition comprises an organic, fluorescent taggant as described in detail above, in an adhesive carrier and is disposed on a tobacco product component.

### EXAMPLES

Specific forms will now be described further by way of example. While the following examples demonstrate certain forms of the subject matter disclosed herein, they are not to be interpreted as limiting the scope thereof, but rather as contributing to a complete description.

### Example 1

The following prophetic example is provided to illustrate the benefits of the disclosed methods and compositions.

50 ppmw of a water soluble indocyanine green, available from Akorn Incorporated, of Lake Forest, Ill., is dispersed into a water soluble polyvinyl acetate adhesive, available from H. B. Fuller of St. Paul, Minn., using a speedmixer. The material is mixed for 10.0 minutes at a speed of 2100 RPM. A sample of the material is placed into a Shimadzu 5301 Fluorometer and the excitation and emission spectrographs are recorded. When excited at a wavelength peak of 805 nm, a strong infrared emission is noted from 810 nanometers to 860 nanometers.

The adhesive/taggant mixture is placed in a cigarette packaging machine and the machine is operated to produce a run of cigarette packs. A plurality of packs is selected from the run and inspected using ultraviolet light having a wavelength peak of 805 nm. Upon excitation, an infrared emission peak is noted at 835 nanometers.

### Example 2

The following prophetic example is provided to illustrate the benefits of the disclosed methods and compositions.

Once again, 50 ppmw of a water soluble indocyanine green, available from Akorn Incorporated, of Lake Forest, Ill., is dispersed into a water soluble polyvinyl acetate adhesive, available from H. B. Fuller of St. Paul, Minn., using a speedmixer. The material is mixed for 10.0 minutes at a speed of 2100 RPM.

The adhesive/taggant mixture is placed in a cigarette carton making machine and the machine is operated to produce a run of cigarette cartons. A plurality of cartons is selected from the run and inspected using ultraviolet light having a wavelength of 805 nm. Upon excitation, an infrared emission is noted at 835 nanometers.

As may be appreciated, other tobacco- and non-tobacco-related consumer product applications can benefit from the subject matter disclosed herein. Contemplated tobacco-related applications include cigars, cigarillos, MST, pouched tobacco products, dry snuff, chewing tobacco and snus.

Illustrative, non-exclusive examples of compositions and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

PCT 1. An adhesive composition comprising an organic taggant compound and an adhesive which decomposes upon pyrolysis or combustion primarily to carbon dioxide and water.

PCT 2. The adhesive composition of paragraph PCT 1, wherein the organic taggant is one which decomposes upon pyrolysis or combustion primarily to carbon dioxide and water.

PCT 3. The adhesive composition of paragraph PCT 1 or PCT 2, wherein the organic taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

PCT 4. The adhesive composition of paragraphs PCT 1-PCT 3, wherein the organic taggant is a Stokes shifting taggant.

PCT 5. The adhesive composition of paragraphs PCT 1-PCT 4, wherein the organic taggant is selected from the group consisting of quinine, fluorescein, carmine, indocyanine green and derivatives thereof.

PCT 6. The adhesive composition of paragraphs PCT 1-PCT 5, wherein the organic taggant is present in the composition at a concentration from about 0.5 ppmw to about 1.0 wt %.

PCT 7. The adhesive composition of paragraphs PCT 1-PCT 5, wherein the adhesive is a water soluble polyvinyl acetate, vegetable starch, dextrin or derivative thereof.

PCT 8. A tobacco product comprising a tobacco rod, a wrapper and an adhesive disposed on said tobacco product, wherein the adhesive is one which decomposes upon pyrolysis or combustion primarily to carbon dioxide and water and further comprises an organic taggant compound.

PCT 9. The tobacco product of paragraph PCT 8, wherein the product is a cigarette and the adhesive is disposed on a tobacco rod wrapper.

PCT 10. The tobacco product of paragraph PCT 8, wherein the product is a cigar and the adhesive is disposed on a tobacco rod wrapper which is a tobacco leaf.

PCT 11. The tobacco product of paragraphs PCT 8-PCT 11, wherein the adhesive is a water soluble polyvinyl acetate, vegetable starch, dextrin or derivative thereof and the organic taggant is a Stokes shifting taggant which decomposes upon pyrolysis or combustion primarily to carbon dioxide and water.

PCT 12. The tobacco product of paragraphs PCT 8-PCT 1, wherein the organic taggant is present in the adhesive at a concentration from about 0.5 ppmw to about 1.0 wt %.

PCT 13. A process for authentication of a tobacco product, comprising: marking said tobacco product with a taggant composition comprising an organic, fluorescent taggant and a carrier for said taggant; irradiating said tobacco product with invisible radiation; and detecting fluorescence from said taggant.

PCT 14. The process of paragraph PCT 13, wherein the organic, fluorescent taggant is one which decomposes upon pyrolysis or combustion primarily to carbon dioxide and water.

PCT 15. The process of paragraph PCT 13 or PCT 14, wherein the organic, fluorescent taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

PCT 16. A process for detecting a tobacco product component, comprising: marking said tobacco product component with a taggant composition comprising an organic, fluorescent taggant and a carrier for said taggant; irradiating said tobacco product component with invisible radiation; and detecting fluorescence from said taggant.

PCT 17. The process of paragraph PCT 16, wherein the organic, fluorescent taggant is one which decomposes upon pyrolysis or combustion primarily to carbon dioxide and water.

PCT 18. The process of paragraphs PCT 16 or PCT 17, wherein the organic, fluorescent taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

PCT 19. An ink composition, comprising an organic taggant compound and an ink.

PCT 20. The ink composition of paragraph PCT 19, wherein the organic taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

### INDUSTRIAL APPLICABILITY

The compositions and methods disclosed herein are applicable to the food, consumer product and tobacco industries.

It is noted that the foregoing examples have been provided merely for the purpose of explanation and are in no way to be construed as limiting. While aspects have been described with reference to an exemplary form, it is understood that the words which have been used herein are words of description and illustration, rather than words of limitation. Changes may be made, within the purview of the appended claims, as presently stated and as amended, without departing from the scope and spirit of the present disclosure in its aspects. Although aspects have been described herein with reference to particular means, materials, and/or forms, the present disclosure is not intended to be limited to the particulars disclosed herein; rather, it extends to all functionally equivalent structures, methods and uses, such as are within the scope of the appended claims.

We claim:

1. An adhesive composition comprising an organic taggant compound and an adhesive which decomposes upon pyrolysis or combustion primarily to carbon dioxide and water.

2. The adhesive composition of claim 1, wherein the organic taggant is one which decomposes upon pyrolysis or combustion primarily to carbon dioxide and water.

3. The adhesive composition of claim 1, wherein the organic taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

4. The adhesive composition of claim 1, wherein the organic taggant is a Stokes shifting taggant.

5. The adhesive composition of claim 1, wherein the organic taggant is selected from the group consisting of quinine, fluorescein, carmine, indocyanine green and derivatives thereof.

6. The adhesive composition of claim 1, wherein the organic taggant is present in the composition at a concentration from about 0.5 ppmw to about 1.0 wt %.

7. The adhesive composition of claim 1, wherein the adhesive is a water soluble polyvinyl acetate, vegetable starch, dextrin or derivative thereof.

8. The adhesive composition of claim 7, wherein the adhesive is an oxidatively- or hydrolytically-degraded starch or dextrin.

9. The adhesive composition of claim 7, wherein the vegetable starch is a starch selected from potato starch, corn starch, tapioca starch or rice starch.

10. The adhesive composition of claim 7, wherein the adhesive is an α-D-glucose biopolymer.

11. A tobacco product comprising a tobacco rod, a wrapper and an adhesive disposed on said tobacco product, wherein the adhesive is one which decomposes upon pyrolysis or combustion primarily to carbon dioxide and water and further comprises an organic taggant compound.

12. The tobacco product of claim 11, wherein the product is a cigarette and the adhesive is disposed on a tobacco rod wrapper.

13. The tobacco product of claim 11, wherein the product is a cigar and the adhesive is disposed on a tobacco rod wrapper which is a tobacco leaf.

14. The tobacco product of claim 11, wherein the adhesive is a water soluble polyvinyl acetate, vegetable starch, dextrin or derivative thereof and the organic taggant is a Stokes shifting taggant which decomposes upon pyrolysis or combustion primarily to carbon dioxide and water.

15. The tobacco product of claim 11, wherein the organic taggant is detectable by visual inspection upon irradiation with non-visible radiation.

16. The tobacco product of claim 11, wherein the organic taggant is present in the adhesive at a concentration from about 0.5 ppmw to about 1.0 wt %.

17. The tobacco product of claim 11, wherein the adhesive is disposed on the filter tack line.

18. The tobacco product of claim 11, wherein the adhesive is disposed on the wrapper seam.

19. The tobacco product of claim 17, wherein the adhesive is disposed on the wrapper seam.

20. A process for authentication of a tobacco product, comprising:
marking said tobacco product with a taggant composition comprising an organic, fluorescent taggant and a carrier for said taggant;
irradiating said tobacco product with invisible radiation; and
detecting fluorescence from said taggant.

21. The process of claim 20, wherein the organic, fluorescent taggant is one which decomposes upon pyrolysis or combustion primarily to carbon dioxide and water.

22. The process of claim 20, wherein the organic, fluorescent taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

23. The process of claim 20, wherein the organic, fluorescent taggant is a Stokes shifting taggant.

24. The process of claim 23, wherein the organic, fluorescent taggant is selected from the group consisting of quinine, fluorescein, carmine, indocyanine green and derivatives thereof.

25. The process of claim 20, wherein the carrier is selected from the group consisting of inks, adhesives and varnishes, and the organic, fluorescent taggant is present in the taggant composition at a concentration of between about 0.5 ppmw and about 1.0 wt %.

26. The process of claim 20, wherein the taggant composition comprises said organic, fluorescent taggant in an adhesive carrier and is disposed on a tobacco rod.

27. The process of claim 20, wherein the taggant composition comprises said organic, fluorescent taggant in a jettable ink carrier, further comprising disposing said taggant composition with an ink jet printer onto an exterior portion of a container for said tobacco product.

28. The process of claim 20, wherein the taggant composition comprises said organic, fluorescent taggant in a carrier varnish, further comprising disposing said taggant composition onto a cardboard preprint prior to cutting and folding said cardboard preprint into containers for said tobacco product.

29. A process for detecting a tobacco product component, comprising:
marking said tobacco product component with a taggant composition comprising an organic, fluorescent taggant and a carrier for said taggant;
irradiating said tobacco product component with invisible radiation; and
detecting fluorescence from said taggant.

30. The process of claim 29, wherein the organic, fluorescent taggant is one which decomposes upon pyrolysis or combustion primarily to carbon dioxide and water.

31. The process of claim 29, wherein the organic, fluorescent taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

32. The process of claim 29, wherein the organic, fluorescent taggant is a Stokes shifting taggant.

33. The process of claim 32, wherein the organic, fluorescent taggant is selected from the group consisting of quinine, fluorescein, carmine, indocyanine green and derivatives thereof.

34. The process of claim 29, wherein the carrier is selected from the group consisting of inks, adhesives and varnishes, and the organic, fluorescent taggant is present in the taggant composition at a concentration of between about 0.5 ppmw and about 1.0 wt %.

35. The process of claim 29, wherein the taggant composition comprises said organic, fluorescent taggant in an adhesive carrier and is disposed on a tobacco product component.

36. An ink composition, comprising an organic taggant compound and an ink.

37. The ink composition of claim 36, wherein the organic taggant is selected from the group consisting of pyrazolines, oxinates, benzoxazinones, benzimidazoles, anthranilic acids, terephthalic acids, aldazines, coumarins, barbituric acids, lumiphores, oxazoles, cumene, stilbenes, cyanine dyes, polymethine dyes, quinolines, fluorescein, and derivatives thereof.

38. The ink composition of claim 36, wherein the organic taggant is a Stokes shifting taggant.

39. The ink composition of claim 36, wherein the organic taggant is selected from the group consisting of quinine, fluorescein, carmine, indocyanine green and derivatives thereof.

40. The ink composition of claim 36, wherein the organic taggant is present in the composition at a concentration from about 0.5 ppmw to about 1.0 wt %.
